(19) United States
(12) Patent Application Publication
(10) Pub. No.: US 2004/0194863 A1
(43) Pub. Date: Oct. 7, 2004

(54) Tire with improved inner liner

(76) Inventor: Michael D. Grah, Simpsonville, SC (US)

Correspondence Address: FELIPE J. FARLEY, PATENT DEPT., MICHELIN N.A., INC., 515 MICHELIN ROAD, GREENVILLE, SC, 29605, US

(21) Appl. No.: 10/172,278

(22) Filed: Jun. 14, 2002

Related U.S. Application Data
(60) Provisional application No. 60/298,332, filed on Jun. 14, 2001.

(51) Int. Cl. B60C 1/00; B60C 5/14; B29D 30/06; C08K 3/34

(52) U.S. Cl. 152/510; 524/445; 156/123

(57) ABSTRACT

The present invention is a pneumatic tire comprising an inner liner, where the inner liner comprises a mixture of a vinyl-based polymer having a polar functionality and organoclay. In a preferred embodiment, the vinyl-based polymer comprises a mixture of a co-polymer of isobutylene and para-methyl styrene. In a particularly preferred embodiment, the co-polymer is halogenated.

The present invention is also a process for making a pneumatic tire, comprising the steps of placing the above-described inner liner in the interior of a tire, stretching the inner liner, and heating the assemblage. In another embodiment of the invention, the inner liner is exposed to water as it is heated.

### RELATED APPLICATIONS

The present application claims priority to U.S. S. No. 60/298,332 titled “Tire with Improved Inner Liner,” filed 14 Jun. 2001, naming as inventor Michael D. Grah.

### FIELD OF THE INVENTION

The present invention is in the field of pneumatic tires, more specifically in the field of inner liners and inner tubes for pneumatic tires.

### BACKGROUND OF THE INVENTION

Pneumatic tires must be constructed of materials that retain air pressure, sometimes over 150 pounds per square inch, over significant periods of time. In pneumatic tires without innertubes, this air retention function is performed by the inner liner. It is typically a thin layer of rubber immediately inside the carcass (main body) of the tire. The inner liner is typically made of a butyl rubber, since the rubbers used in the main body of the tire often are too permeable to oxygen to use in the inner liner. Butyl rubber is more expensive than many of the other rubbers of the tire, and its incorporations serves to increase the mass, cost, and rolling resistance of the tire.

Underinflation is the enemy of a pneumatic tire. An underinflated tire becomes hotter than a properly inflated tire, degrades more quickly, and its tread wears more quickly. Decreasing the air permeability of a tire can help it stay properly inflated longer, and therefore give the tire a longer service life. Decreasing the air permeability of a tire can have another salutary effect. Since the tire is under pressure, air is forced from the hollow inside of the tire, through the rubber carcass of the tire, to the outside atmosphere. Since a tire heats as it rolls across a road, the migration of oxygen through the tire can cause thermo-oxidative breakdown of the rubber of the carcass. Decreasing the air permeability of the tire can reduce the rate of thermo-oxidative breakdown.

Therefore, there is a need for a pneumatic tire with reduced air permeability.

### SUMMARY OF THE INVENTION

The present invention is a pneumatic tire comprising an inner liner, where the inner liner comprises a mixture of a vinyl-based polymer having a polar functionality and organoclay. In a preferred embodiment, the vinyl-based polymer comprises a mixture of a co-polymer of isobutylene and para-methyl styrene. In a particularly preferred embodiment, the co-polymer is halogenated.

The present invention is also a process for making a pneumatic tire, comprising the steps of placing the above-described inner liner in the interior of a tire, stretching the inner liner, and heating the assemblage. In another embodiment of the invention, the inner liner is exposed to water as it is heated.

### DETAILED DESCRIPTION OF THE INVENTION

The present invention is a pneumatic tire comprising an inner liner, where the inner liner comprises a mixture of a vinyl-based polymer having a polar functionality and organoclay. In a preferred embodiment, the vinyl-based polymer comprises a mixture of a co-polymer of isobutylene and para-methyl styrene. In a particularly preferred embodiment, the co-polymer is halogenated.

The present invention is also a process for making a pneumatic tire, comprising the steps of placing the above-described inner liner in the interior of a tire, stretching the inner liner, and heating the assemblage. The inner liner is thus adjacent to other components of the tire as it is heated. In another embodiment of the invention, the inner liner is exposed to water as it is heated.

The tire of the present invention has far greater impermeability to air than the prior art, while the inner liner of the tire retains its flexibility, rupture strength, and endurance.

The present invention is more particularly described below.

Vinyl-Based Polymers

The vinyl-based polymer compound is a generic name to denote a polymer composed of monomers having a vinyl group. It is represented by the general formula below.

—[CH₂—C(R¹)(R²)]ₙ—

(where R¹ and R² independently denote a hydrogen atom, halogen atom, alkyl group, aryl group, allyl group, or substituted group, which may be the same or different.) The vinyl-based polymer compounds may be used alone or in combination with one another. However, in all cases the vinyl-based polymer must have a polar functionality to insure proper exfoliation of the organoclay. Examples of a polar functionalities include halogens such as bromine, chlorine, and fluorine and the cyano group. The monomer of the vinyl-based polymer includes, but is not limited to, ethylene, propylene, butadiene, isoprene, chloroprene, vinyl chloride, vinylidene chloride, vinyl fluoride, vinylidene fluoride, styrene, and alpha-methylstyrene. They may be used alone or in combination. (see U.S. Pat. No. 4,889,885, incorporated by reference).

In a preferred embodiment, polymers such as bromobutyl, copolymers such as isobutene and isoprene rubber, natural rubber, and polyisoprene can all be utilized with the present invention. In a particularly preferred embodiment, the formula represents a mixture of a halogenated co-polymer of isobutylene and para-methyl styrene.

The Organoclay

An organoclay (organopolysilicate) is a clay such as kaolin or montmorillonite, to which organic structures have been chemically associated, sometimes by bonding, sometimes by charge interactions. Since the surfaces of the clay particles, which have a lattice-like arrangement, are negatively charged, they are capable of binding organic radicals. Useful materials include phyllosilicates, such as smectite clay minerals, e.g., montmorillonite, such as sodium montmorillonite; magnesium montmorillonite, and calcium montmorillonite; nontronite; beidellite; volkonskoite; hectorite; saponite; sauconite; sobockite; stevensite; svinfordite; vermiculite; and the like, and bentonite. Other useful layered materials include micaceous minerals, such as illite and mixed layered illite/smectite minerals, such as ledikite and admixtures of illites with the clay minerals named above.

In the present invention, the organic structure to which the clay is associated is a surfactant. One portion of the surfactant molecule is an onium ion represented by:

-M⁺R¹R²R³—

(where M denotes N, S, P, or pyridinium, and R¹, R², and R³ independently denote hydrogen atoms, alkyl groups, aryl groups, or allyl group, which may be the same or different). Also contemplated by the present invention are arsonium, stibonium, arsonium, selenonium, and stibonium compounds. (see U.S. Pat. No. 2,531,427, incorporated by reference).

Other Materials

Other materials, such as anti-oxidants, accelerators, fillers (such as carbon black or silicas), and processing aids may be present in the inner liner. The layer of the tire immediately adjacent the inner liner may contain aromatic oils (Sun Co., Exton, Pa.), anti-oxidants such as 6PPD (N-(1,3-dimethylbutyl)-N′-phenyl-p-phenylenediamine) and CBS (Santocure CBS (N-cyclohexylbenzothiazyl sulphenamide), Flexsys America (Akron, Ohio, 44334)), and cobalt, which might migrate to the inner liner.

Formulation of the Inner Liner and a Tire

The compositions of this invention are prepared by using a conventional rubber mixing process. Typical fillers, curatives, and processing agents can be included in the composition without negatively affecting the permeability. Organically functionalized silicates are added at a loading level of 0.1-20 phr (parts by weight of additive per hundred parts by weight rubber), more preferably 0.2-10 phr, and most preferable 0.5-5 phr loadings. Typical organoclays include montmorillonite clay functionalized with quaternary amines such as di-methyl, di-tallow ammonium and octadecyl amine. Tradenames for some typical organically modified clays include Cloisite 6A (Southern Clay Products, Inc., Gonzales, Tex.), Nanomer 1.31PS (Nanocor Inc., Arlington Heights, Ill.), and Elementis Al 04 (Elementis Catalysts, Inc., Allentown, Pa.). This invention works with a variety of organoclays with different clay type, levels of organic content, and onium ion or quaternary amine functionality.

The rubber may be mixed with the organoclay with a standard mixer, such as a Banbury mixer (Farrel Corp., Ansonia, Conn.) or a Brabender mixer (C.W. Brabender Instruments Inc., NJ). During the mixing process, the organoclay becomes exfoliated in the rubber compound. The exfoliation process produces a good dispersion of clay platelets with high aspect ratio. Forming of the rubber by processes such as extrusion or calendering impart a preferred orientation to the exfoliated platelets in the rubber. This orientation is ultimately perpendicular to the direction of gas migration.

The inventor has found that the curing conditions used to vulcanize the rubber have a dramatic influence on the final permeability of the rubber-clay composite. Water vapor must be present during the cure, along with the requisite pressure and temperature necessary to vulcanize the rubber (In the examples, heating at about 160 degrees Celsius for about thirty minutes, at about 16 bars pressure). If water vapor is not present, the large reduction in permeability is not realized. Although the present invention is not bound by theory, in one embodiment of the invention the water vapor may diffuse into the rubber during the cure and catalyze the reaction of brominated paramethylsytrene to an ammonium-based surfactant. The resulting reactant product greatly reduces the permeability of the interface between the elastomer and the clay surface, resulting in surprisingly improved permeability. Further, the stiffness and elasticity of the rubber is not changed by the presence of the exfoliated organoclay when prepared in this manner. Thus, when used as a tire innerliner, this material provides for significantly enhanced air retention without a negative impact on innerliner fatigue or endurance.

The present invention is a pneumatic tire comprising an inner liner, wherein the inner liner comprises a mixture of co-polymer of isobutylene and para-methyl styrene, and organoclay. In one embodiment of the invention, the co-polymer is halogenated, the halogen is selected from the group consisting of chlorine and bromine. In one embodiment of the invention, the inner liner is comprised of approximately between 0 and 20 parts by weight organoclay per hundred parts by weight elastomer of the inner liner. In another embodiment, the inner liner is between 0.2 and 10 parts by weight organoclay per hundred parts by weight elastomer of the inner liner. In another embodiment, the inner liner is comprised of approximately between 0.5 and 5 parts by weight organoclay per hundred parts by weight elastomer of the inner liner.

The present invention is also a process of making a pneumatic tire comprising the steps of placing an inner liner in the interior of the tire and heating the tire, where the inner liner comprises a mixture of co-polymer of isobutylene and para-methyl styrene, and organoclay. In one embodiment of the invention the co-polymer is halogenated, and the halogen is selected from chlorine and bromine. The inner liner may be treated with heated water vapor while the tire is heating.

The present invention is also a process of making a pneumatic tire comprising the steps of:

(a) placing an inner liner in the interior of the tire;

(b) placing the tire on a tire mold;

(c) exposing the inner-liner to water;

(d) heating the tire;

where the inner liner comprises a mixture of halogenated co-polymer of isobutylene and para-methyl styrene, and organoclay.

The inner liner may initially contain a surfactant to help disperse the organoclay in the elastomer.

In one embodiment of the invention, the clay of the organoclay may be selected from phyllosilicates and micaceous minerals.

The invention may also be described as a cured pneumatic tire comprising an inner liner, where the inner liner comprises a vinyl rubber having a polar functionality and organoclay. In one embodiment the vinyl rubber is chosen from polymers whose monomers are selected from the group consisting of: ethylene, propylene, butadiene, isoprene, chloroprene, vinyl chloride, vinylidene chloride, vinyl fluoride, vinylidene fluoride, styrene, alpha.-methylstyrene, and mixtures thereof. The invention may also be described as a tire comprising an inner liner, where the inner liner comprises organoclay and a vinyl rubber, where the vinyl rubber includes a functionality which helps exfoliate the organoclay in the rubber.

Non-limiting examples of the tire of the present invention are set forth below.

### EXAMPLE 1

| | Control 1 | Control 2 | A | B | C |
|---|---|---|---|---|---|
| Exxpro 93-4 | 100 | | 100 | 100 | |
| Exxpro 96-4 | | 100 | | | 100 |
| Nanomer I.30T | | | 4 | | |
| Nanomer I.31PS | | | | | 3 |
| Cloisite 6A | | | | 3 | |
| N772 | 50 | 50 | 50 | 50 | 50 |
| Tack. Resin | 2.5 | 2.5 | 2.5 | 2.5 | 2.5 |
| Curatives | 6.2 | 6.2 | 6.2 | 6.2 | 6.2 |
| Mooney Viscosity 100° C. (ML 1 + 4) | 79 | 82 | 79 | 72 | 82 |
| Modulus @ 10% strain (MPa) | 3.1 | 3.0 | 3.0 | 2.7 | 3.0 |
| Modulus @ 100% strain (MPa) | 1.4 | 1.4 | 1.3 | 1.2 | 1.4 |
| Modulus @ 300% strain (MPa) | 1.4 | 1.5 | 1.3 | 1.3 | 1.5 |
| Ultimate Rupture stress (MPa) | 13.4 | 13.8 | 11.5 | 13.9 | 13.8 |
| Ultimate Rupture strain (%) | 609 | 589 | 505 | 590 | 589 |
| Lab O₂ Permeability @ 40° C. | 121 | 107 | 110 | 115 | 107 |
| (cc * mm/m2 * day) | | | | | |
| % reduction in permeability versus | — | — | −9% | −5% | 0% |
| control | | | | | |
| Tire Air retention (% loss/month) | 0.87% | 1.18% | 0.66% | 0.61% | .85% |
| @ 65° C. | | | | | |
| % improvement in tire air retention | — | — | 25% | 30% | 28% |
| versus control | | | | | |
| Predicted % reduction in innerliner | — | — | −41% | −45% | −47% |
| permeability versus control (from tire | | | | | |
| data) | | | | | |
| Tire low pressure endurance (40,000 km) | Good | Good | Good | Good | Good |

N772 is carbon black, available from, for example, CS Cabot, Inc. (Masarykova 753; 757 27 Valasske Mezirici; Czech Republic)

Nanomer—available from Nanocor (Arlington Heights, Ill.)

Tack. Resin—“tackifying resin”

Rubber was compounded in a Banbury mixer by a known rubber compounding process. Typical vulcanization agents were used at ratios and levels known to one skilled in the art. A typical loading of carbon black, and a typical tackifying resin was also utilized in each composition. Two different versions of a co-polymer of isobutylene and para-methyl styrene (Exxpro™, Exxon Chemical Corp., Baytown, Tex.) were utilized as described in Control 1 and Control 2. Three different organoclays were used at concentrations of 3 or 4 phr.

Mooney viscosity readings indicate that organoclay loading had no negative impact on processability. In fact, for composition B, the viscosity was reduced, suggesting improved processibility. In the cured state, the presence of the organoclay was found to have no impact on the modulus or ultimate properties of the rubber formulation.

The level of exfoliation of the organoclays was determined by measuring x-ray diffraction of the samples, and observing the spectrum at low angles (2°-10° 2 theta.) No diffraction peaks were present at 2 theta angles less than 10° C., suggesting that the organoclay was exfoliated. Transmission electron microscopy of the samples confirmed that the organoclay particles were dispersed primarily as single platelets with a high level of orientation perpendicular to the direction of oxygen migration through the test plaques. The level of oxygen permeability at 40° C. was determined for lab plaques with a MOCON Ox-Tran 2/20 (Modern Controls Corp., Minneapolis, Minn.) Plaques prepared for evaluation by this technique were vulcanized in a press under dry conditions. Compared to the controls, the compositions containing exfoliated organoclay exhibited levels of permeability equal to or slightly lower than those of the controls did.

Tires were fabricated with the inner-liner prepared according to the above description. Prior to curing the tire, the internal surface of the tire was sprayed with a water-based mold release. Even when air-dried, this mold release contains substantial amounts of bound water, which is released during the tire cure. The tires given in the examples were cured in a tire press for about 18 minutes at a maximum temperature of 165° C. and 16 atmospheres pressure.

In contrast to the lab plaques, when the compositions organoclay were built into innerliners and vulcanized as part of a tire, the resulting tires exhibited air retention levels surprisingly higher than the control tires. More surprisingly, when liner permeability levels were determined from the air retention data, the permeability levels of the liners containing exfoliated organoclay were found to be much lower than the levels found in lab plaques prepared from identical compositions.

The inner liners prepared according to the current invention have the same flexibility, endurance, and rupture strength as the controls, as shown by the above data. In the laboratory setting, they appeared to have about the same oxygen permeability. However, when formed into a tire, the tires surprisingly exhibited thirty percent (30%) reductions in air loss.

I claim:

1. A pneumatic tire comprising an inner liner, wherein the inner liner comprises a mixture of co-polymer of isobutylene and para-methyl styrene, and organoclay.

2. The tire of claim 1 wherein the co-polymer is halogenated, and wherein the halogen is selected from the group consisting of chlorine and bromine.

3. The tire of claim 1 wherein the inner liner is comprised of approximately:
between 0 and 20 parts by weight organoclay per hundred parts by weight elastomer of the inner liner;
wherein the elastomer of the inner liner is a co-polymer of isobutylene and para-methyl styrene.

4. The tire of claim 1 wherein the inner liner is comprised of approximately:
between 0.2 and 10 parts by weight organoclay per hundred parts by weight elastomer of the inner liner;
wherein the elastomer of the inner liner is a co-polymer of isobutylene and para-methyl styrene

5. The tire of claim 1 wherein the inner liner is comprised of approximately:
between 0.5 and 5 parts by weight organoclay per hundred parts by weight elastomer of the inner liner;
wherein the elastomer of the inner liner is a co-polymer of isobutylene and para-methyl styrene

6. An inner liner for a pneumatic tire comprising a mixture of co-polymer of isobutylene and par-methyl styrene, and organoclay.

7. The inner liner of claim 3 wherein the co-polymer is halogenated, and wherein the halogen is selected from the group consisting of chlorine and bromine.

8. A process of making a pneumatic tire comprising the steps of:
(a) placing an inner liner in the interior of the tire;
(b) heating the tire;
wherein the inner liner comprises a mixture of co-polymer of isobutylene and para-methyl styrene, and organoclay.

9. The process of claim 8, wherein the co-polymer is halogenated, and wherein the halogen is selected from the group consisting of chlorine and bromine.

10. A process of making an inner-liner for a pneumatic tire comprising the step of heating the inner liner while treating the inner liner with heated water vapor, wherein the inner liner comprises a mixture of halogenated co-polymer of isobutylene and para-methyl styrene, and organoclay.

11. A process of making a pneumatic tire comprising the steps of:
(e) placing an inner liner in the interior of the tire;
(f) placing the tire on a tire mold;
(g) exposing the inner-liner to water;
(h) heating the tire;
wherein the inner liner comprises a mixture of halogenated co-polymer of isobutylene and para-methyl styrene, and organoclay.

12. A process of making a pneumatic tire comprising the steps of:
(a) placing an inner liner in the interior of the tire;
(b) placing the tire on a tire mold;
(c) exposing the inner-liner to water;
(d) heating the tire;
wherein the inner liner comprises a mixture of halogenated co-polymer of isobutylene and para-methyl styrene, and organoclay;
and wherein the inner liner initially contains a surfactant to disperse the organoclay throughout the inner-liner.

13. The tire of claim 1, wherein the clay of the organoclay is selected from the group consisting of phyllosilicates and micaceous minerals.

14. A cured pneumatic tire comprising an inner liner, wherein the inner liner comprises a vinyl rubber having a polar functionality and organoclay.

15. The tire of claim 14, wherein the vinyl rubber is chosen from polymers whose monomers are selected from the group consisting of: ethylene, propylene, butadiene, isoprene, chloroprene, vinyl chloride, vinylidene chloride, vinyl fluoride, vinylidene fluoride, styrene, alpha.-methylstyrene, and mixtures thereof.

16. A tire comprising an inner liner, wherein the inner liner comprises organoclay and a vinyl rubber, wherein the vinyl rubber includes a functionality which helps exfoliate the organoclay in the rubber
